(19) United States
(12) Patent Application Publication
(10) Pub. No.: US 2021/0252589 A1
(43) Pub. Date: Aug. 19, 2021

(54) METHOD AND APPARATUS FOR ADDITIVE MANUFACTURING OF A COMPONENT

(71) Applicant: GROB-WERKE GmbH & Co. KG, Mindelheim (DE)

(72) Inventors: Benjamin HIMMEL, München (DE); Johannes GLASSCHRÖDER, Neusäß (DE); Martin OTTER, Memmingen (DE); Oliver LEUSCH, Augsburg (DE); Christian MIKLEC, Bad Wörishofen (DE)

(21) Appl. No.: 17/177,801

(22) Filed: Feb. 17, 2021

(30) Foreign Application Priority Data
Feb. 19, 2020 (DE) 10 2020 104 296.5

(51) Int. Cl. B22D 23/00; B33Y 10/00; B33Y 30/00

(52) U.S. Cl. CPC B22D 23/003; B33Y 30/00; B33Y 10/00

(57) ABSTRACT

In a method and a device for additive manufacturing using a liquid material (16), a support structure (12) is used to form, on the support structure, a component (10) that may have one or more overhangs. For easy separation of the component (10) from the support structure, a separation structure (14) made of solidified material (16) is formed therebetween by changing at least one operating parameter when the separation structure is applied. As a result, a poorer or weaker connection (cohesion) of the material of the separation structure to the material of the support structure and/or to the material of the component is obtained. The change of the at least one operating parameter can be effected, for example, by selective cooling of the liquid material during application of the separation structure and/or by oxidation of the liquid material during application of the separation structure.

### CROSS-REFERENCE

The present application claims priority to German patent application serial number 10 2020 104 296.5 filed on 19 Feb. 2020, the contents of which are incorporated fully herein by reference.

### TECHNICAL FIELD

The present disclosure concerns a method and an apparatus for additive manufacturing (e.g., 3-D printing) of a component, in particular by using a support structure that at least partially supports the component during the additive manufacturing steps.

### BACKGROUND ART

Various known additive manufacturing methods enable a component to be manufactured layer by layer. Typical methods for the buildup of metallic components are, for example, the method known as “Laser Powder Bed Fusion” (LPBF), the “Direct Energy Deposition” method and the so-called “Material Jetting” (MJT) method, wherein molten material is printed (dispensed) using a printhead through one or more individually-controlled nozzles directly onto a build platform.

Additive manufacturing methods are characterized by having a high degree of design freedom and by performing the manufacturing in a tool-less manner. Therefore, such methods are suited, in particular, for individual parts and components having a high degree of complexity, which can not be produced with conventional manufacturing methods or only at great expense. In such additive manufacturing methods, the work pieces are built up, layer by layer or element by element, based on digital models (designs), i.e. digital design data such as computer-aided design (CAD) data. However, in known methods, workpieces (components) having, e.g., starkly overhanging (cantilevered) portions can be manufactured only by using additional axes for the printhead and/or for the build platform, or by using support structures. Such support- or assist-structures are necessary in powder bed methods in order to ensure the necessary mechanical and thermal connection to the component, or in powder-free methods in order to provide a base for the material deposition.

### SUMMARY OF THE INVENTION

An example of a component 10 having an overhang, which is additively manufactured using a support structure, is shown in FIG. 1. It is apparent in FIG. 1 that, even though an overhang, such as the tip of the arrow, can be manufactured up to a certain angle without support structures, a corresponding (complementary) support structure 12 must be provided to enable starkly overhanging (cantilevered) portions, such as the horizontal shaft of the arrow, to be formed.

In MJT-methods, it is possible to apply, via a second printhead, another material that can be thermally or chemically separated from the material of the component after completion of the manufacturing of the component. For example, a plastic (polymer) or a salt can be used as the other material. Such methods are described in U.S. Pat. No. 10,315,247 B2.

It is therefore an object of the present teachings to disclose techniques for using support structures in additive manufacturing methods such that the support structures can be simply and efficiently manufactured and/or can be readily separated (detached) from the manufactured component.

In some additive manufacturing methods, a molten material (e.g., a molten metal) is printed onto a build platform using one or more nozzles to eject (dispense, print) droplets of the molten material. In such methods, the quality (strength, cohesion) of the connection (bonding) between the individual droplets is determined, inter alia, by the prevailing temperatures of the underlying layer, on which the droplets are deposited, by the degree of oxidation of this underlying layer, and by the degree of oxidation of the liquid droplets.

In one aspect of the present teachings, a separation layer is applied (deposited) onto the support structure, wherein one or more process parameters (operating parameters) are adjusted during the manufacture of this separation layer such that a poor connection (weak bonding) or no connection (no bonding) between the underlying layer and the separation layer results. This makes possible, in particular, the manufacture of the support structure from (using) the same material (molten material) as the material that is to be used for forming the component. Therefore, one advantage of this aspect is that it is possible to use only a single printhead (and optionally a single material (molten material)) to form both the separation layer and the component. Furthermore, another advantage of this aspect is that no additional axes of movement for the printhead and/or the build platform are required. These two advantages mean that a significant reduction of work and expense in the construction of a corresponding facility and/or apparatus for performing such an additive manufacturing technique can be realized.

To impair or weaken the connection (bonding) between the separation layer and the support structure and/or the component, the surface of the support structure and/or the flying droplets can be locally cooled. In the alternative or in addition thereto, the deposited droplets and/or the flying droplets can be intentionally oxidized during the application of the separation layer, for example, by introducing a liquid or gaseous oxidation medium. This can be realized in a particularly simple manner by using commonly-available media, such as oxygen gas or air.

Additional objects, embodiments, features and advantages of the present teachings will become apparent from the following description of detailed embodiments and from the claims with reference to the figures.

### BRIEF DESCRIPTION OF THE DRAWINGS

FIG. 1 is a schematic view, which shows a technique for additive manufacturing a component by using a support structure.

FIG. 2 is a schematic view of an apparatus for additive manufacturing of a component according to a first representative, non-limiting embodiment of the present teachings.

FIG. 3 is a view for visualizing the application of a separation layer according to the first representative, non-limiting embodiment.

FIG. 4 is a view for visualizing the application of a material layer onto the separation layer that was formed in FIG. 3.

FIG. 5 is a schematic view of a printhead according to a second representative, non-limiting embodiment of the present teachings.

### DETAILED DESCRIPTION OF THE EMBODIMENTS

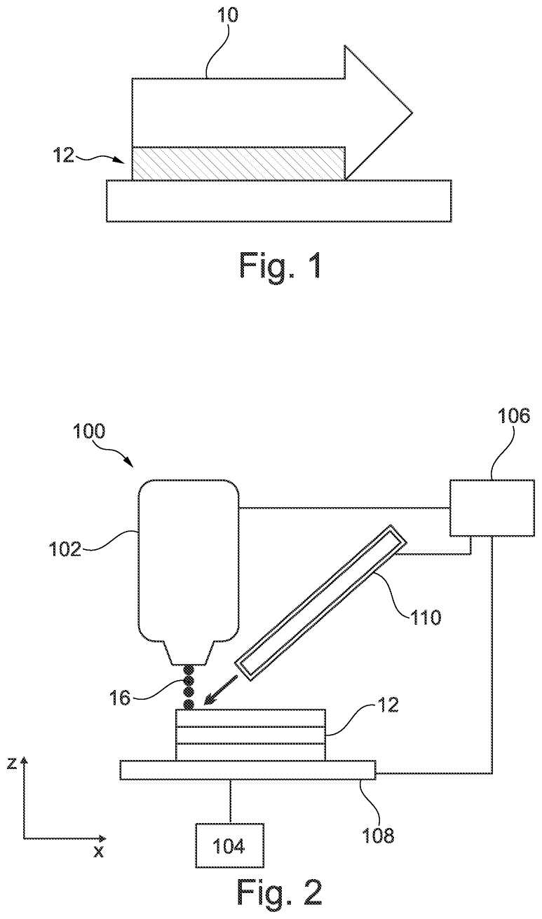

FIG. 2 is a schematic view of an apparatus 100 for additive manufacturing of a component 10 according to a first representative, non-limiting embodiment of the present teachings. For example, the component (arrow) 10 shown in FIG. 1 may be manufactured (fabricated, produced) using the apparatus 100.

The apparatus 100 includes a printhead 102 configured to apply (deposit, dispense, print) a liquid material, such as a molten metal, such as, without limitation, preferably aluminum (Al) alloys or copper (Cu) alloys, or other metals having relatively low melting points, such as tin (Sn) alloys or zinc (Zn) alloys. The liquid material may be applied (deposited) in a known manner in the form of droplets by ejecting the liquid material in droplet form from the printhead 102, such as is generally the case in the above-mentioned MJT-method. Details relating to the manner of application of the liquid material are therefore omitted from the present description.

As is also known, the apparatus 100 includes a displacing device 104 configured to displace (move) the printhead 102 and the to-be-manufactured component 10 relative to one another. In the present embodiment, the displacing device 104 is configured, for example, to displace a base 108, on which the component 10 is manufactured, relative to the printhead 102.

For example, the displacing device 104 may be embodied as an X, Y motorized mechanism that moves the base 108 in a plane perpendicular to an extension direction of the print head 102, which may be held in a stationary manner. Of course, in other embodiments, the displacing device 104 can be configured to displace the printhead 102 relative to the base 108 and/or to the to-be-manufactured component 10, and if necessary to tilt it. In such an embodiment, the displacing device 104 may be embodied as an X, Y motorized mechanism that moves the printhead 102 in a plane parallel to the upper surface of the base 108, which may be held in a stationary manner. Naturally, the displacing device 104 may be configured to move both the base 108 and the printhead 102. The displacing device 104 may include, e.g., two motors (such as two linear motors) that respectively move the base 108 and/or the printhead 102 in the X direction and the Y direction, respectively. The displacing device 104 is electrically connected, either wirelessly or by wire, to a control device 106 configured to control the printhead 102 and the displacing device 104, for example to displace the one or both of the printhead 102 and the base 108.

Furthermore, the control device 106 is configured to control the printhead 102 to apply (eject, dispense, print) liquid material 16 for forming the support structure 12 that will support at least a portion of the to-be-manufactured component 10, in particular an overhanging (cantilevered) portion of to-be-manufactured component 10. In the exemplary embodiment shown in FIG. 2, multiple layers are applied one on top of the other in order to form a substantially rectangular (cuboid) support structure 12.

In the present embodiment, the material 16 for manufacturing the support structure is applied in a manner analogous to the application of the material 16 during the manufacture of the component 10. In other words, the support structure 12 is manufactured under essentially the same conditions as the component 10, and is composed of the same material and has essentially the same properties. It is to be understood, however, that in other embodiments of the present teachings, even though the material 16 for the support structure can be the same as the material for the component 10, one or more properties of the support structure 12 can differ from the properties of the component 10, for example, by changing one or more operating parameters when forming the support structure 12 as compared to the same operating parameters when forming the component 10. Such changeable operating parameters include without limitation, for example, one or more of the size of the ejected droplets of the applied material, the ejection speed of the droplets, the lateral distance between ejected droplets (i.e. the distance between droplets in a plane parallel to the surface of the base 108), and/or the vertical distance between the nozzle that ejects the droplets and the upper surface (solid material) on which the droplets will be deposited.

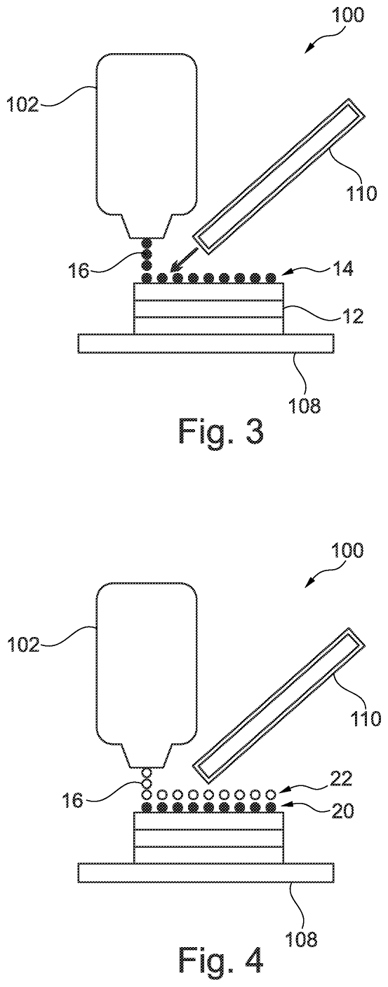

After completion of the support structure 12, the control device 106 is configured to form a separation structure (separating layer) 14 by applying the (same) liquid material 16 to the support structure 12 using the (same) printhead 102. That is, as shown in FIG. 3, a material layer of the separation structure 14 is applied to (on) the support structure 12 by using the printhead 102. The control device 106 is further configured to change at least one operating (process) parameter during the application of the separation structure 14 to change at least one property of the material 16 that is applied when the separation structure 14 is formed and/or at least one property of the material (solid material) 16 to (on) which the separation structure 14 is applied (formed). As result, after the separation structure 14 is completed, at least one property of the separation structure 14 will differ from the to-be-manufactured component 10 and/or from the support structure 12. To achieve this result in the present embodiment, the control device 106 controls a cooling apparatus 110 configured to supply a cooling medium, which is for example a protective gas such as nitrogen gas (N₂) or air.

The cooling apparatus 110 may be embodied, e.g., as a pressurized gas tank, a pressurized gas supply or even as a fan, which has a nozzle to direct the flow of gas towards the ejected droplets while in flight or toward the surface (solid material), on which the droplets are deposited, in order to cool the surface.

In this embodiment, the operating parameter is the amount or rate of the cooling medium (e.g., a gas flow) that will be supplied, as will be explained below. However, it should be understood that the cooling medium does not have to be gaseous. For example, suitable liquid cooling media, such as liquid protective gases (nitrogen, argon, helium), also can be used as the cooling medium in modified embodiments of the present teachings.

In particular, the control device 106 preferably controls the cooling apparatus 110 such that the temperature of the material 16 that is applied when (while) the separation structure 14 is formed and/or the temperature of the material 16 (i.e. solid upper layer), onto which the separation structure 14 is applied, is lower than the temperature of the material 16 during the formation of the component 10 and optionally during the formation of the support structure 12. In other words, in the present embodiment, the control device 106 activates the cooling apparatus 110 either before the application of the separation structure 14 or during the application of the separation structure 14. In this way, the temperature of either the top layer of the support structure 12 or the layer of the separation structure 14 is reduced. This leads to an impaired or incomplete connection (weak bonding) of the droplets between the top layer (e.g., the uppermost surface) of the support structure 12 and the layer of the separation structure 14.

It is possible that the change in the property of the material when forming the separation structure 14 will lead to the corresponding material layer that differs from the height of the material layer in the component 10 and possibly in the support structure 12. In order to avoid this height difference, at least one additional operating parameter for adjusting the height of the layer of the separation structure can be changed while the separation structure 14 is being formed. This at least one additional operating parameter can include, for example, any one of the operating parameters mentioned above, i.e. one or more of the size of the ejected droplets of the applied material, the ejection speed of the droplets, the lateral distance between ejected droplets (i.e. the distance between droplets in a plane parallel to the surface of the base 108), the vertical distance between the nozzle that ejects the droplets and the upper surface on which the droplets will be deposited.

After application (deposition) of the separation structure 14, which for example can be composed of a single deposited layer 20 of the material 16 as shown in FIG. 4, the control device 106 is further configured to form at least a portion of the to-be-manufactured component 10 by applying (depositing) the liquid material 16 onto the separation structure 14 using the printhead 102. As long as this is not already done before the layer of the separation structure 14 is applied, the at least one operating parameter is changed accordingly (back) so that (again) a good connection (strong bonding) of the individual droplets, for example of the subsequent layer 22 of the to-be-manufactured component 10, is obtained. During the additive manufacture of the additional layers of the component 10, the operating parameters preferably remain constant. That is, in the present embodiment, the cooling apparatus 110 preferably remains deactivated while the component 10 is being fabricated layer by layer.

In this way, the component 10, as shown for example in FIG. 1, can be completed on the support structure 12. As was noted above, the separation structure 14 shown in FIG. 3 is provided, for example, with the layer 20 having altered material properties (in particular, having a poorer connection (weaker bond) between the separation structure 14 and the support structure 12 than, for example, between the individual layers of the component 10). Therefore, after the completion of the manufacture of the component 10, the component 10 can easily be separated (detached) from the separation structure 14. More specifically, in the present exemplary embodiment, because the separation structure 14 exhibits a relatively low cohesion due to the poorer connection (weaker bonding) between the droplets thereof, and the separation structure 14 will substantially disintegrate when the finished component 10 is separated (detached) from the support structure 12. Therefore, the at least one operating parameter is preferably changed during the formation of the separation structure 14 (separating layer 20) such that, e.g., the material strength (e.g., tensile strength or ultimate tensile strength) of the separation structure 14 is weaker or less than the material strength of the component 10 (and also optionally weaker or less than the material strength of the support structure 12), in particular with regard to tensile stress, and/or the separation structure 14 is more brittle than the component 10 (and also optionally more brittle than the support structure 12), again in particular with regard to tensile stress. Therefore, for example, if a tensile stress (pulling force) is applied to the component 10, the component 10 will separate or detach from the support structure 12 along the separation structure 14. In other words, the separation structure 14 is designed to break (fail) prior to breakage (failure) of the component 10 (and preferably also prior to breakage (failure) of the support structure 12). Preferably, the material strength strength (e.g., tensile strength or ultimate tensile strength) of the separation structure 14 is at least 10% less than the material strength of the component 10 (and also optionally at least 10% less than the material strength of the support structure 12), in particular with regard to tensile stress, more preferably at least 20% less, at least 30% less or even at least 50% less.

Any portion of the separation structure 14 that remains on the component 10 can easily be removed, e.g., by a suitable cleaning technique (washing, blowing off, etc.). In some embodiments, however, a layer of the separation structure can also remain on the component 10 and form a part (the outermost layer) thereof. In any case, no complex processes, such as chemical or electrochemical etching and the like, need to be used in order to separate (detach) the component 10 from the support structure 12. Furthermore, as was already explained, the support structure 12 and the separation structure 14 can be manufactured from (using) the same material as the component 10, so that the support structure 12 and component 10 can be manufactured using a single printhead and a single source of liquid material 16.

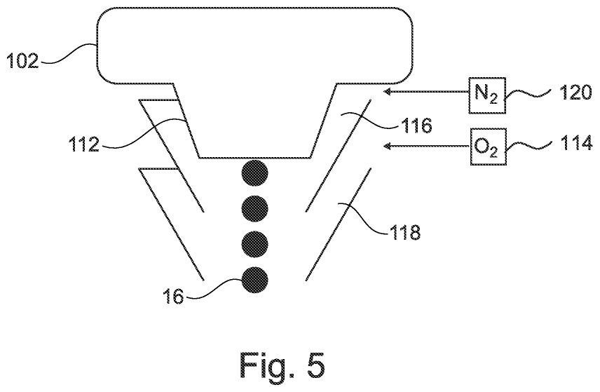

FIG. 5 shows a second representative, non-limiting embodiment of the present teachings. In the embodiment shown in FIG. 5, the apparatus 100 further includes an oxidizing gas supply apparatus 114, which is configured to supply an oxidizing gas, for example O₂, in a region downstream of a region of an opening 112 of the printhead 102. In the present embodiment, the control device 106 is configured to control the oxidizing gas supply apparatus 114 to increase the degree of oxidation of the material 16 applied during the formation of the separation structure 14, as compared to the degree of oxidation of the material 16 applied during the formation of the component 10 and possibly also during the formation of the support structure 12.

For this purpose, the oxidizing gas supply apparatus 114 in the present embodiment is fluidly connected to a nozzle that surrounds the opening 112 and has two spaced-apart concentric inlets 116, 118. The oxidizing gas (e.g., O₂) is preferably supplied via the outer one (118) of the inlets. Optionally, a protective gas, such as N₂, can be fed from a protective gas supply device 120 to the inner one (116) of the inlets. The protective gas is preferably directed against the tip of the nozzle to protect the nozzle from forming metal oxide deposits thereon and to protect the generation of the droplets. The protective gas supply device 120 is activated, for example, on an ongoing basis; i.e. protective gas is continuously supplied during the formation of all of the support structure 12, the separation structure 14 and the component 10. On the other hand, only during the generation of the separation structure 14 (see FIG. 3) or the separation layer 20 (see FIG. 4), a small gas flow of the oxidizing gas is added (injected) via the inlet 118, to effect the change in the at least one operating parameter according to the present embodiment. As a result, the oxidizing gas (e.g., oxygen) content surrounding the droplets is raised during the flight of the droplets while depositing the separation layer 14, whereby the surface of the droplets of liquid material 16 oxidizes more quickly.

Because the surface of the droplets will become more significantly oxidized (than during the formation of the component 10, in which the oxidizing gas is not supplied), the oxidized droplets will bind more poorly (weakly) to the previously-deposited material, for example to the top layer of the support structure 12. Furthermore, these oxidized droplets will form the separation structure 14 or separation layer 20, which will have a reduced cohesion as compared to the solid material of the support structure 12 and the solid material of the component 10. Following the formation of the separation structure 14, the at least one operating parameter is changed back again. That is, the supply of the oxidizing gas is stopped and then the component 10 is formed on top of the separation structure 14 or separation layer 20 without supplying the oxidizing gas, whereby the material of the component 10 has higher cohesion.

In this way, after completion of the component 10, the component 10 can be readily separated or detached from the support structure 12 owing to the poorer connection (weaker bonding) at the boundary between the top layer of the support structure 12 and the layer of the separation structure 14. In the present embodiment as well, at least one additional operating parameter can be adjusted in order to maintain a constant layer height. As a result, in both the present embodiment and in the embodiment described above, the separation structure 14 can have one to five layers and is designed to substantially disintegrate during separation, or one layer of the separation structure 14 can remain adhered to the component 10 and form part of the component 10. In some applications of the present teachings, the separation structure 14 may be composed of a single layer 20 of deposited droplets.

The oxidizing gas supply apparatus 114 and/or the protective gas supply device 120 may be embodied, e.g., as a pressurized gas tank, a pressurized gas supply or a fan, which has a nozzle to direct the oxidizing gas or protective gas towards the droplets of the material 16 while in flight.

In the above-described embodiments, one or more changes of the at least one property when forming the separation structure 14 ensures that, in particular, the connection (bonding) between the top layer of the support structure 12 and the adjoining layer of the separation structure 14 is impaired (weakened). However, it should be understood that, in other embodiments of the present teachings, in particular, the connection between the top layer of the separation structure 14 and the first layer of the component 10 formed thereon can be impaired by the measures described above. In this case, the separation structure 14 does not remain on the component 10, but rather can be viewed as part of the support structure 12. In other variants, the connection (bonding) between the support structure 12 and the separation structure 14 as well as the connection (bonding) between the separation structure 14 and the component 10 can be intentionally impaired (weakened) in order to achieve a reliable separation between the support structure 12 and the component 10.

Furthermore, it should be understood that it is also sufficient if, for example, only the temperature of the underlying layer of the support structure 12 is reduced when the droplets of the material 16 of the separation structure 14 are applied. In addition or in the alternative thereto, the temperature of the applied droplets can be reduced, for example, while traveling (flying) along the path from the nozzle opening to the base 108. The same also applies to embodiments in which the connection (bonding) between the separation structure 14 and the component 10 is to be impaired (weakened) by utilizing an appropriate cooling technique during the deposition of the separation structure 14.

It also should be understood that, in the embodiment shown in the FIG. 5 or in modifications thereof, the degree of oxidation of the droplets applied and/or the degree of oxidation of the layer, on which the droplets are applied, can be increased. This applies regardless of whether the connection between the support structure 12 and the separation structure 14 or the connection between the separation structure 14 and component 10 is to be deliberately impaired. Furthermore, a combination of the cooling of the first embodiment with the oxidizing gas of the second embodiment is also within the scope of the present teachings.

It should be understood that the above-mentioned properties of temperature and degree of oxidation are only exemplary, and other appropriate properties can be changed by intentionally controlling (changing) one or more operating parameters while forming the separation structure 14, as long as such control (change) leads to a poorer connection (weaker bonding or cohesion) of the droplets forming the separation structure 14 to the support structure 12 and/or to the component 10. For example, the distances between the individual droplets of the separation structure 14 in a lateral direction (i.e. parallel to the upper surface of the base 108) could be increased in order to produce porous structures having reduced strength in the separation structure 14.

Furthermore, the shapes of the support structure 12 and of the component 10 that were explained above also are merely exemplary. In other words, in other aspects of the present teachings, the support structure 12 can have any shape that deviates from the right-angled (cuboid) shape shown in the Figures. The same applies to the shape of the component 10.

In addition, the manufacturing need not take place layer by layer, as is shown for example in FIGS. 2 to 4. In other words, the separation structure 14 can have any desired, possibly one-dimensional or even three-dimensional shape, corresponding (complementary) to the desired shape of the component 10. Furthermore, the entire component 10 does not have to be formed on the support structure 12. For example, only a portion of the component 10 may be formed on (supported by) the support structure 12, such as in the case of the arrowhead in the example shown in FIG. 1, in which only the horizontal shaft part is supported by the support structure 12.

The method steps recited in the present description and the appended claims do not necessarily have to be carried out in the recited order, but rather can be carried out in any chronological order, provided that it is technically reasonable and does not lead to a conflict. In particular, a layer-by-layer production can take place such that a support structure or a separation structure is formed in some regions in one plane, whereas a part of the component 10 is formed in other regions of the same plane. This corresponds, for example, to the case shown in FIG. 1, wherein in the lower portions (layers) the support structure 12 is formed on the left side and the head of the arrow is formed on the right side within the same horizontal plane. In other words, each individual layer (horizontal plane) can have one or more regions in which the support structure or the separation structure is formed, and one or more regions in which a part of the component is formed. In such embodiments of the present teachings, the change of the at least one operating parameter or the change of the at least one property can take place within an individual layer and/or in multiple successive layers. It can be seen that the control device 106 performs an appropriate control such that the change takes place at the corresponding points (for example, at the transitions between the support structure 12 and the arrowhead of the component 10 in FIG. 1 when the support structure 12 and the component 10 are built up in layers at the same time).

In addition or as an alternative to the above-described examples of the at least one operating parameter, one or more additional operating parameters can also be used, and the change of the additional operating parameter(s) can contribute to the fact that the to-be-manufactured component can be easily separated or detached from the support structure.

In one example, the at least one operating parameter can, as was already mentioned, be changed such that a lateral distance between droplets of the material of the separation structure is increased in order to form the above-mentioned pores in the separation structure, thereby weakening the cohesion (reducing the material strength) of the separation structure. For example, the rate at which the droplets are released (ejected) from the printhead and/or the relative speed between the printhead and the substrate can be suitably adjusted to form such pores.

In other examples, the at least one operating parameter can include a vertical distance between the printhead and the surface (solid material), on which the material is applied, wherein the change is effected such that the flight time (the time between ejection of the droplet and impact of the droplet on the particular material) of the droplet of the material is increased when (while) the separation structure is being applied. In such an embodiment, the temperature of the material when (while) forming the separation structure (i.e. when the droplets forming the separation structure 14 impact the surface) is reduced as compared to the temperature of the material when forming the component (i.e. when the droplets forming the component 10 impact the surface). Furthermore, the degree of oxidation of the material when forming the separation structure can thereby be increased compared to the degree of oxidation of the material when forming the component. This can be adjusted, for example, by changing the vertical distance between the printhead and the base, wherein it should be understood that one or both of the printhead and the base can be moved to achieve the different vertical distance therebetween.

Furthermore, the at least one operating parameter can include a power output of a heater that heats the base, on which the component is disposed. This change can be effected (for example, the power output can be reduced) such that the temperature of the material, to which the separation structure is applied, is reduced as compared to the temperature of the material when forming the component. This also leads to the result that the separation structure can be separated more easily from the component.

It should be understood that the above-mentioned three examples for additional operating parameters can be suitably combined with one another and with the operating parameters described above, if this is desired.

In embodiments, in which the at least one operating parameter involves the cooling medium and/or the oxidizing gas, the change of the at least one operating parameter may be effected by changing the flow rate of the cooling medium and/or the oxidizing gas by at least 10% while forming the separation structure 14 or separation layer 20, more preferably by at least 20%, more preferably by at least 50% and possibly by 90% or more, such as 100% (i.e. the supply of the cooling medium and/or the oxidizing gas is provided only during the formation of the separation structure 14 or separation layer 20 and is completely shut off at all other times).

In embodiments, in which the at least one operating parameter involves changing the vertical distance and/or the flight time between the nozzle of the printhead 102 and the uppermost surface (solid material), on which the liquid material 16 is deposited, the change of the at least one operating parameter may be effected by increasing this vertical distance and/or flight time by at least 100% while the separation structure 14 or separation layer 20 is being formed as compared to the vertical distance while the component 10 is being formed, more preferably by at least 200%, more preferably by at least 300% and possibly even by 900% or more, for example, from around 1 mm up to around 10 mm.

In such embodiments, in which the vertical distance is variable, the displacing device 104 is preferably configured as an X,Y,Z moving mechanism comprising at least three motors (e.g., linear motors) that respectively move either the base 108 or the printhead 102 or both of the base 108 and the printhead 102 in the X-, Y- and Z-directions. For example, it is possible that a portion of the X,Y,Z moving mechanism is operably coupled to the base 108 to move the base 108 in the X- and Y-directions (i.e. in the plane parallel to the upper surface of the base 108), and a portion of the X,Y,Z mechanism is operably coupled to the printhead 102 to move the printhead 102 in the Z direction (i.e. in a direction perpendicular the plane parallel to the upper surface of the base 108). In the alternative, it is possible that a portion of the X,Y,Z moving mechanism is operably coupled to the printhead 102 to move the printhead 102 in the X- and Y-directions (i.e. in the plane parallel to the upper surface of the base 108), and a portion of the X,Y,Z mechanism is operably coupled to the base 108 to move the base 108 in the Z direction (i.e. in a direction perpendicular to the plane parallel to the upper surface of the base 108). It is noted that, if the printhead 102 spans the entire X-direction of the base 108 (or the entire X-direction of a to-be-manufactured component 10), then it is only necessary for the base 108 and printhead 102 to move relative to each other in the Y-direction (and possibly in the Z-direction).

In embodiments, in which the at least one operating parameter involves changing the size of the droplets of the liquid material 16, the change of the at least one operating parameter may be effected by decreasing droplet size by at least 10% while the separation structure 14 or separation layer 20 is being formed as compared to the droplet size while the component 10 is being formed, more preferably by at least 20%, more preferably by at least 30% and possibly even by 50% or more.

In embodiments, in which the at least one operating parameter involves changing the speed of the relative movement between the base 108 and the printhead 102, the change of the at least one operating parameter may be effected by increasing the speed of relative movement by at least 10% while the separation structure 14 or separation layer 20 is being formed as compared to the speed while the component 10 is being formed, more preferably by at least 50%, more preferably by at least 100% and possibly even by 200% or more.

In embodiments, in which the at least one operating parameter involves changing the lateral distances between droplets of the liquid material 16, the change of the at least one operating parameter may be effected by increasing the lateral distance between droplets by at least 10% while the separation structure 14 or separation layer 20 is being formed as compared to the lateral distance while the component 10 is being formed, more preferably by at least 50%, more preferably by at least 100% and possibly even by 200% or more.

Generally speaking, it is preferable that the at least one operating parameter is changed such that the temperature of the droplets of the liquid material 16 at the time of impact on the upper surface of the support structure 12 or separation structure 14 while the separation structure 14 or separation layer 20 is being formed is at least 10° C. lower than the temperature of the droplets of the liquid material 16 at the time of impact on the upper surface of the separation structure 14, the separation layer 20 or the partially-completed component 10 while the component 10 is being formed, more preferably at least 20° C. lower, more preferably at least 30° C. lower and possibly even 50° C. lower.

Depending on design requirements, exemplary embodiments of the control device 106 of the present disclosure may be implemented in hardware and/or in software. The control device 106 can be configured using a digital storage medium, for example one or more of a ROM, a PROM, an EPROM, an EEPROM, a flash memory, etc., on which electronically readable control signals (program code—instructions) are stored, which interact or can interact with one or more programmable hardware components to execute programmed functions.

The (each) programmable hardware component can be constituted by a processor, which may comprise a computer processor (CPU=central processing unit), an application-specific integrated circuit (ASIC), an integrated circuit (IC), a computer, a system-on-a-chip (SOC), a programmable logic element, and/or a field programmable gate array (FGPA). A microprocessor is a typical component of a control device 106 or processor according to the present teachings.

The digital storage medium can therefore be machine- or computer readable. Some exemplary embodiments thus comprise a data carrier or non-transient computer readable medium which includes electronically readable control signals which are capable of interacting with a programmable computer system or a programmable hardware component such that one of the methods or functions described herein is performed. An exemplary embodiment is thus a data carrier (or a digital storage medium or a non-transient computer-readable medium) on which the program for performing one of the methods described herein is recorded.

In general, exemplary embodiments of the present disclosure, in particular the control device 106, are implemented as a program, firmware, computer program, or computer program product including a program, or as data, wherein the program code or the data is operative to perform one of the methods when the program runs on (is executed by) a processor or a programmable hardware component. The program code or the data can for example also be stored on a machine-readable carrier or data carrier, such as any of the types of digital storage media described above. The program code or the data can be, among other things, source code, machine code, bytecode or another intermediate code.

A program according to an exemplary embodiment can implement one of the methods or functions during its performance, for example, such that the program reads storage locations and/or writes one or more data elements into these storage locations, wherein switching operations or other operations are induced in transistor structures, in amplifier structures, or in other electrical, electronic, optical, magnetic components, or components based on another functional or physical principle. Correspondingly, data, values, sensor values, or other program information can be captured, determined, or measured by reading a storage location. By reading one or more storage locations, a program can therefore capture, determine or measure sizes, values, variables, and other information, as well as cause, induce, or perform an action by writing in one or more storage locations, as well as control other apparatuses, machines, and components, and thus for example also perform any complex process that the air compressor may be designed to perform.

Although some aspects of the present teachings have been described in the context of a device or apparatus, it is to be understood that these aspects also represent a description of a corresponding method, so that a block or a component of a device or apparatus is also understood as a corresponding method step or as a feature of a method step. In an analogous manner, aspects which have been described in the context of or as a method step also represent a description of a corresponding block or detail or feature of a corresponding device.

Additional embodiments of the present disclosure include, but are not limited to:

1. Method for additive manufacturing of a component (10) by applying a liquid material (16) using a printhead (102), having the following steps:

applying the liquid material (16) using the printhead (102) to form a support structure (12) for the component (10) to be manufactured;

forming a separation structure (14) by applying the liquid material (16) to the support structure (12) using the printhead (102);

forming at least a portion of the to-be-manufactured component (10) on the separation structure by applying the liquid material (16) using the printhead (102); and

separating the component (10) from the support structure (12) at the separation structure (14),

wherein at least one operating parameter is changed such that at least one property of the material (16) that is applied when forming the separation structure (14) and/or of the material (16), to which the separation structure (14) is applied, differs from the at least one property of the material (16) when forming the component (10).

2. Method according to the above Embodiment 1, wherein the at least one operating parameter includes an amount of a cooling medium, for example, a protective gas such as N₂ or air, which is supplied, wherein the change is effected such that the temperature of the material (16) that is applied during formation of the separation structure (14), and/or of the material (16) to which the separation structure (14) is applied is reduced relative to the temperature of the material (16) when the component (10) is formed.

3. Method according to the above Embodiment 1 or 2, wherein the at least one operating parameter includes an oxygen concentration, wherein the change is effected such that a degree of oxidation of the material (16) that is applied when forming the separation structure (14) and/or of the material (16), to which the separation structure (14) is applied, is increased relative to a degree of oxidation of the material (16) when the component (10) is formed.

4. Method according to the above Embodiment 3, further comprising:

supplying a protective gas in a region of an opening (112) of the printhead (102); and

supplying an oxidizing gas in a region downstream of the supply of the protective gas to increase the degree of oxidation of the applied material (16) during the formation of the separation structure (14).

5. Method according to any one of the above Embodiments 1 to 4, wherein the applying of the liquid material (16) is effected layer by layer, wherein a layer (20) of the separation structure (14) has substantially a same height as a layer (22) of the component (10).

6. Method according to the above Embodiment 5, wherein the separation structure (14) has one to five layers (20), in particular is formed from a single layer (22).

7. Method according to the above Embodiment 5 or 6, further with changing of at least one additional operating parameter during the formation of the separation structure (14) to adjust the height of the layer (20), wherein the at least one additional operating parameter includes, for example, a size, a speed and/or a time interval of droplets of the applied material (16).

8. Method according to any one of the preceding Embodiments, wherein the at least one operating parameter is changed such that the distances between the droplets of the material of the separation structure (14) are increased, so that porous structures having reduced strength are produced.

9. Method according to the above Embodiment 8, wherein the at least one operating parameter includes a rate, at which the droplets are dispensed from the printhead (102), and/or the relative speed between the printhead (102) and a base (108), on which the component (12) is disposed.

10. Method according to any one of the preceding Embodiments, wherein the at least one operating parameter includes a distance between the printhead (102) and the surface to which the material (16) is applied, wherein the distance is changed such that, when forming the separation structure (14), the flight time of the individual droplets is increased compared to that when forming the component (12), and/or the degree of oxidation of the individual droplets is increased compared to that when forming the component (12).

11. Method according to any one of the preceding Embodiments, wherein the at least one operating parameter includes a power output of a heater of a base (108) on which the component (12) is disposed, wherein the change is effected such that the temperature of the material (16), to which the separation structure (14) is applied, is reduced compared to that when forming the component (12).

12. Apparatus (100) for additive manufacturing of a component (10), having:

a printhead (102) that is configured to apply a liquid material (16);

a displacing device (104) that is configured to displace the printhead (102) and the to-be-manufactured component (10) relative to one another; and

a control device (106) that is configured to control the printhead (102) and the displacing device (104) to:
apply the liquid material (16) using the printhead (102) to form a support structure (12) for the to-be-manufactured component (10);
form a separation structure (14) by applying the liquid material (16) to the support structure (12) using the printhead (102);
form at least part of the to-be-manufactured component (10) by applying the liquid material (16) to the separation structure (14) using the printhead (102),

wherein the control device is further configured to change at least one operating parameter such that at least one property of the material (16) that is applied when forming the separation structure (14) and/or of the material (16), to which the separation structure (14) is applied, differs from the at least one property of the material (16) when forming the component (10).

13. Apparatus according to the above Embodiment 12, further comprising a cooling device (110) that is configured to supply a cooling medium, for example a protective gas such as N₂ or air, wherein the control device (106) controls the cooling device (110) such that the temperature of the material (16) that is applied when forming the separation structure (14) and/or of the material (16), to which the separation structure (14) is applied, is reduced compared to the temperature of the material (16) when forming the component (10).

14. Apparatus according to the above Embodiment 12 or 13, further comprising an oxidizing gas supply device (114) that is configured to supply an oxidizing gas, for example O₂, in a region downstream of a region of an opening (112) of the printhead (102), wherein the control device (106) controls the oxidizing gas supply device (114) to increase the degree of oxidation of the material (16) that is applied during the formation of the separation structure (14).

15. Apparatus according to the above Embodiment 14, wherein the oxidizing gas supply device (114) includes a nozzle surrounding the opening (112) and has two spaced-apart concentric inlets (116, 118), wherein the oxidizing gas is supplied via the outer one of the inlets.

It is explicitly emphasized that all of the features disclosed in the description and/or the claims should be considered as separate and independent from one another for the purpose of the original disclosure as well as for the purpose of limiting the claimed invention, independent of the combinations of features in the embodiments and/or the claims. It is explicitly stated that all range specifications or specifications of groups of units disclose every possible intermediate value or subgroup of units for the purpose of the original disclosure as well as for the purpose of limiting the claimed invention, in particular also as the limit of a range specification.

Representative, non-limiting examples of the present invention were described above in detail with reference to the attached drawings. This detailed description is merely intended to teach a person of skill in the art further details for practicing preferred aspects of the present teachings and is not intended to limit the scope of the invention. Furthermore, each of the additional features and teachings disclosed above may be utilized separately or in conjunction with other features and teachings to provide improved methods and apparatuses for additive manufacturing (e.g., 3-D printing) of a component.

Moreover, combinations of features and steps disclosed in the above detailed description may not be necessary to practice the invention in the broadest sense, and are instead taught merely to particularly describe representative examples of the invention. Furthermore, various features of the above-described representative examples, as well as the various independent and dependent claims below, may be combined in ways that are not specifically and explicitly enumerated in order to provide additional useful embodiments of the present teachings.

All features disclosed in the description and/or the claims are intended to be disclosed separately and independently from each other for the purpose of original written disclosure, as well as for the purpose of restricting the claimed subject matter, independent of the compositions of the features in the embodiments and/or the claims. In addition, all value ranges or indications of groups of entities are intended to disclose every possible intermediate value or intermediate entity for the purpose of original written disclosure, as well as for the purpose of restricting the claimed subject matter.

### LIST OF REFERENCE NUMBERS

10 Component
12 Support structure
14 Separation structure
16 Material
20 Layer
22 Layer
100 Apparatus
102 Printhead
104 Displacing device
106 Control device
108 Base
110 Cooling apparatus
112 Opening
114 Oxidizing gas supply device
116 Inlet
118 Inlet
120 Protective gas supply device

We claim:

1. A method for additive manufacturing of a component, comprising:
(a) applying a liquid material using a printhead to form a support structure for use in subsequently fabricating at least one portion of the component;
(b) forming a separation structure on the support structure by applying the liquid material to the support structure using the printhead;
(c) forming the component by applying the liquid material using the printhead such that the at least one portion of the component is formed on the separation structure; and
(d) separating the component from the support structure at or along the separation structure,
wherein at least one operating parameter is changed in at least one of steps (a)-(c) such that:
(i) at least one property of the liquid material that is applied when forming the separation structure differs from the at least one property of the liquid material that is applied when forming the component, and/or
(ii) at least one property of solid material, on which the separation structure is being formed, differs from the at least one property of the solid material, on which the component is being formed, and/or
(iii) at least one property of the solid material forming the separation structure differs from the at least one property of the solid material forming the component and/or the support structure.

2. The method according to claim 1, wherein the at least one operating parameter is changed such that the separation structure has a material strength that is less than a material strength of the at least one portion of the component.

3. The method according to claim 1, wherein the at least one operating parameter is changed such that the separation structure is more brittle than the at least one portion of the component.

4. The method according to claim 1, wherein:
the at least one operating parameter includes an amount of a cooling medium that cools the liquid material and/or the solid material, and
the at least one operating parameter is changed such that the temperature of the liquid material that is applied during formation of the separation structure and/or the temperature of the solid material, on which the separation structure is being formed, is reduced relative to the temperature of the liquid material when the component is formed.

5. The method according to claim 1, wherein:
the at least one operating parameter includes an oxygen concentration, and
the at least one operating parameter is changed such that a degree of oxidation of the liquid material that is applied when forming the separation structure and/or a degree of oxidation of the solid material, on which the separation structure is formed, is increased relative to a degree of oxidation of the liquid material when the component is formed.

6. The method according to claim 5, further comprising:
supplying a protective gas in a region of an opening of the printhead; and
supplying an oxidizing gas in a region downstream of the supply of the protective gas to increase the degree of oxidation of the liquid material applied during the formation of the separation structure.

7. The method according to claim 1, wherein the liquid material is a molten metal.

8. The method according to claim 1, wherein:
the liquid material is applied layer by layer in an additive manner in steps (a)-(c), and
a or each layer of the separation structure has at least substantially the same height as each layer of the component.

9. The method according to claim 8, wherein the separation structure has one to five layers.

10. The method according to claim 9, wherein:
at least one additional operating parameter is changed during the formation of the separation structure to adjust the height of the layer(s) of the separation structure, and
the at least one additional operating parameter is selected from the group consisting of:
the size of droplets of the liquid material applied to form the separation structure,
the speed of the droplets of the liquid material applied to form the separation structure, and/or
the flight time of the droplets of the liquid material applied to form the separation structure.

11. The method according to claim 1, wherein the at least one operating parameter is changed such that distances between droplets of the liquid material applied to form the separation structure are increased as compared to distances between droplets of the liquid material applied to form the component, so that porous structures having a lower material strength than the component are produced in the separation structure.

12. The method according to claim 11, wherein the at least one operating parameter includes a rate, at which the droplets of the liquid material are dispensed from the printhead, and/or a relative speed between the printhead and a base, on which the component is disposed.

13. The method according to claim 1, wherein:
the at least one operating parameter includes a distance between the printhead and an upper surface of the solid material to which the liquid material is applied, and
the distance is changed, when forming the separation structure, such that:
a flight time of individual droplets of the liquid material is increased as compared to the flight time when forming the component, and/or
a degree of oxidation of the individual droplets is increased as compared to the degree of oxidation of the individual droplets when forming the component.

14. The method according to claim 1, wherein:
the at least one operating parameter includes a power output of a heater of a base on which the component is disposed, and
the at least one operating parameter change is changed such that the temperature of the solid material, to which the separation structure is applied, is reduced as compared to the temperature when forming the component.

15. An apparatus comprising:
a printhead configured to apply a liquid material;
a displacing device configured to displace the printhead and a component relative to one another; and
a control device configured to control the printhead and the displacing device to:
apply the liquid material using the printhead to form a support structure for the to-be-manufactured component;
form a separation structure on the support structure by applying the liquid material to the support structure using the printhead; and
form the component by applying the liquid material using the printhead such that at least part of the component is formed on the separation structure,
wherein the control device is further configured to change at least one operating parameter such that:
(i) at least one property of the liquid material that is applied when forming the separation structure differs from the at least one property of the liquid material that is applied when forming the component, and/or
(ii) at least one property of solid material, on which the separation structure is being formed, differs from the at least one property of the solid material, on which the component is being formed, and/or
(iii) at least one property of the solid material forming the separation structure differs from the at least one property of the solid material forming the component and/or the support structure.

16. The apparatus according to claim 15, further comprising:
a cooling device configured to supply a cooling medium,
wherein the control device is configured to control the cooling device such that the temperature of the liquid material that is applied when forming the separation structure and/or the temperature of the solid material, on which the separation structure is formed, is lower than the temperature of the liquid material when forming the component.

17. The apparatus according to claim 15, further comprising:
an oxidizing gas supply device configured to supply an oxidizing gas in a region downstream of an opening of the printhead,
wherein the control device is configured to control the oxidizing gas supply device to increase a degree of oxidation of the liquid material that is applied during the formation of the separation structure.

18. The apparatus according to claim 17, wherein:
the oxidizing gas supply device includes a nozzle surrounding the opening of the printhead,
the nozzle has an inner inlet and an outer inlet that are spaced apart and concentric, and
the oxidizing gas supply device is configured to supply the oxidizing gas to the outer inlet.

19. The apparatus according to claim 18, further comprising:
a protective gas supply device configured to supply a protective gas to the inner inlet of the nozzle.
